(19) United States
(12) Patent Application Publication
(10) Pub. No.: US 2025/0171285 A1
(43) Pub. Date: May 29, 2025

(54) CARGO HANDLING SYSTEM

(71) Applicant: KABUSHIKI KAISHA TOYOTA JIDOSHOKKI, Kariya-shi (JP)

(72) Inventor: Hirokazu KISHIDA, Kariya-shi (JP)

(73) Assignee: KABUSHIKI KAISHA TOYOTA JIDOSHOKKI, Kariya-shi (JP)

(21) Appl. No.: 18/957,086

(22) Filed: Nov. 22, 2024

(30) Foreign Application Priority Data
Nov. 27, 2023 (JP) 2023-199758

(51) Int. Cl. B66F 9/075; B65G 67/24; B66F 9/14; G06Q 10/08

(52) U.S. Cl. CPC B66F 9/0755; B65G 67/24; B66F 9/142; G06Q 10/08; B65G 2203/0216; B65G 2203/046

(57) ABSTRACT

A cargo handling system in which an industrial vehicle performs cargo handling operation for a transport vehicle includes the industrial vehicle, a work site where the industrial vehicle perform cargo handling operation, a monitoring unit provided at a position in the work site different from the industrial vehicle, and configured to monitor a state of the work site, a pallet on which a cargo is placed, an identification information provider provided in the pallet and providing identification information for identifying at least one of the cargo and the pallet, and a reading unit configured to read the identification information provider. The industrial vehicle performs the cargo handling operation based on the identification information read by the reading unit.

### CROSS-REFERENCE TO RELATED APPLICATION

This application claims priority to Japanese Patent Application No. 2023-199758 filed on Nov. 27, 2023, the entire disclosure of which is incorporated herein by reference.

The present disclosure relates to a cargo handling system.

### BACKGROUND ART

Japanese Patent Application Publication No. 2021-195215 discloses an example of a conventional cargo handling system. In this conventional cargo handling system, an industrial vehicle such as a forklift truck performs cargo handling operation for a transport vehicle. The cargo handling system includes a device, as a ground device, which measures a distance. The cargo handling system measures a distance to a pallet on a loading platform, and transmits instructions related to cargo handling to the industrial vehicle based on the distance information.

In the conventional cargo handling system described above, with the ground equipment alone, which cargo handling operation should be performed may not be sufficiently grasped. In this case, an operator on-site has to make various determinations. Alternatively, a high-performance detection device has to be provided in each industrial vehicle, which increases the cost of the cargo handling system.

The present disclosure has been made to solve the above-mentioned problems, and is directed to providing a cargo handling system that achieves labor-saving while reducing the cost of the cargo handling system.

### SUMMARY

In accordance with an aspect of the present disclosure, there is provided a cargo handling system in which an industrial vehicle performs cargo handling operation to a transport vehicle. The cargo handling system includes the industrial vehicle, a work site where the industrial vehicle perform cargo handling operation, a monitoring unit provided at a position in the work site different from the industrial vehicle, and configured to monitor a state of the work site, a pallet on which a cargo is placed, an identification information provider provided in the pallet and providing identification information for identifying at least one of the cargo and the pallet, and a reading unit configured to read the identification information provider. The industrial vehicle performs the cargo handling operation based on the identification information read by the reading unit.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a side view illustrating an example of an industrial vehicle of a cargo handling system according to the present disclosure;

FIG. 2 is a plan view illustrating an example of the cargo handling system;

FIG. 3 is a front view illustrating the example of the cargo handling system;

FIGS. 4A and 4B each are a schematic diagram illustrating a configuration of a monitoring unit of an industrial vehicle

FIG. 5 is a block diagram illustrating a configuration of the cargo handling system;

FIG. 6 is an image showing a state in which a determination unit makes a determination using artificial intelligence;

FIG. 7 is a flowchart showing an example of processing of the cargo handling system;

FIG. 8 is a flowchart showing the example of processing of the cargo handling system;

FIG. 9 is a flowchart showing the example of processing of the cargo handling system;

FIG. 10 is a flowchart showing the example of processing of the cargo handling system;

FIG. 11 is a flowchart showing an example of processing of the cargo handling system;

FIG. 12 is a flowchart showing the example of processing of the cargo handling system;

FIG. 13 is a flowchart showing the example of processing of the cargo handling system;

FIG. 14 is a flowchart showing an example of processing of the cargo handling system;

FIG. 15 is a flowchart showing the example of processing of the cargo handling system;

FIG. 16 is a flowchart showing the example of processing of the cargo handling system;

FIG. 17 is a flowchart showing the example of processing of the cargo handling system;

FIG. 18 is a flowchart showing the example of processing of the cargo handling system;

FIG. 19 is a flowchart showing the example of processing of the cargo handling system;

FIG. 20 is a flowchart showing the example of processing of the cargo handling system;

FIG. 21 is a flowchart showing the example of processing of the cargo handling system;

FIG. 22 is a flowchart showing the example of processing of the cargo handling system; and

FIG. 23 is a flowchart showing the example of processing of the cargo handling system.

### DETAILED DESCRIPTION OF THE EMBODIMENTS

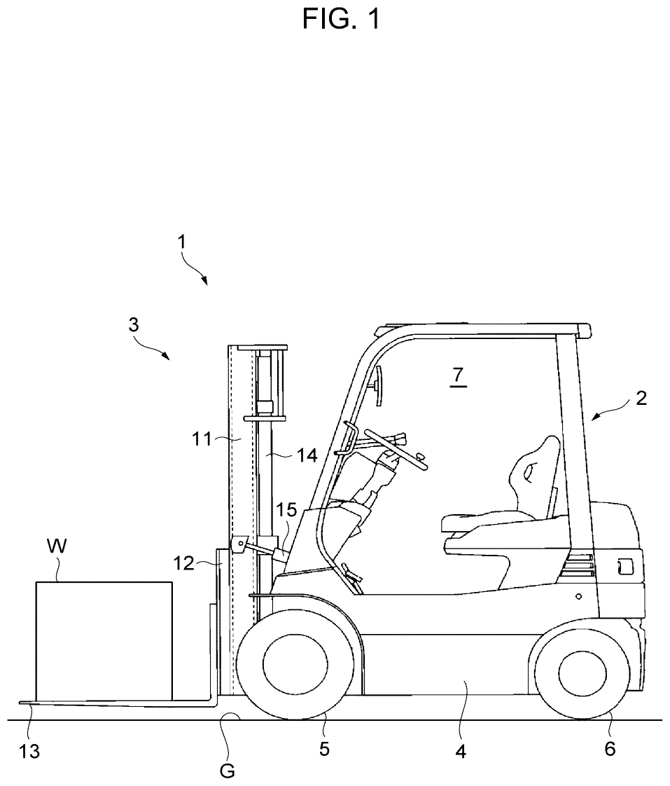

FIG. 1 is a side view illustrating an example of an industrial vehicle 1 according to the present disclosure. The industrial vehicle 1 is a vehicle that performs loading and unloading of a cargo W from a transport vehicle. A forklift truck is used as the industrial vehicle 1. The forklift truck is not limited to any particular type, and may be a reach type or a counter type. As illustrated in FIG. 1, the industrial vehicle 1 includes a travelling device 2, a cargo handling device 3 that is disposed in front of the travelling device 2 and has forks 13, and a travelling control unit that controls travelling of the industrial vehicle 1.

The travelling device 2 includes a vehicle body 4, front wheels 5 which are a pair of drive wheels disposed at the front of the vehicle body 4, and rear wheels 6 which are a pair of steered wheels disposed at the rear of the vehicle body 4. The vehicle body 4 includes an operator's cab 7 formed of a frame including a head guard. A lift operation lever that is used to operate a lift cylinder 14, a tilt operation lever that is used to operate a tilt cylinder 15, a steering wheel for steering the industrial vehicle 1, and the like, are provided in the operator's cab 7. In addition, the travelling device 2 includes a travelling motor that rotates the front wheels 5, and a steering motor that steers the rear wheels 6 by rotating a steering shaft of the industrial vehicle 1. The travelling device 2 causes the travelling motor to rotate the front wheels 5, and the steering motor to steer the rear wheels 6, thereby causing the industrial vehicle 1 to travel.

The cargo handling device 3 includes a mast 11 attached to the front of the vehicle body 4, a pair of forks 13 attached to the mast 11 via a lift bracket 12 and holding a cargo W, the lift cylinder 14 for moving the forks 13 up and down, and the tilt cylinder 15 for tilting the mast 11. The forks 13 are attached to the mast 11 so as to protrude forward from the lift bracket 12.

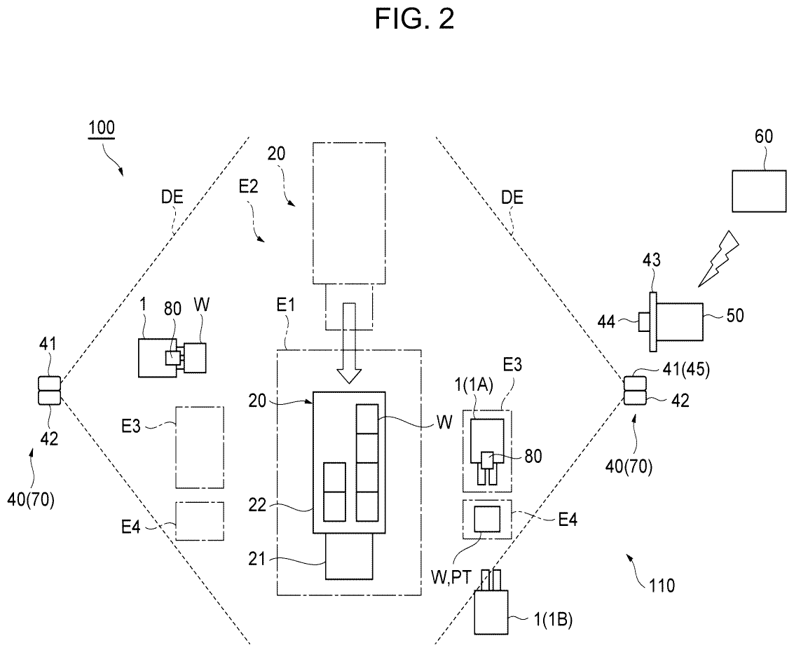

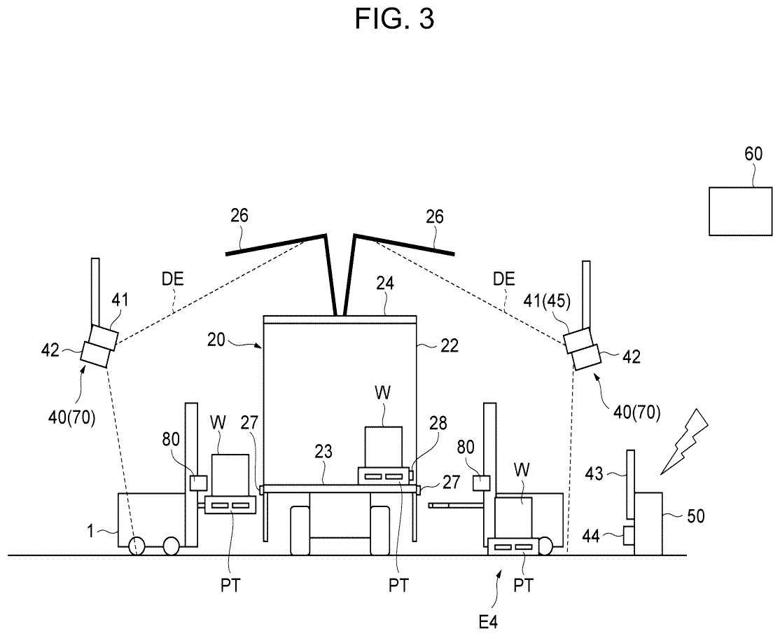

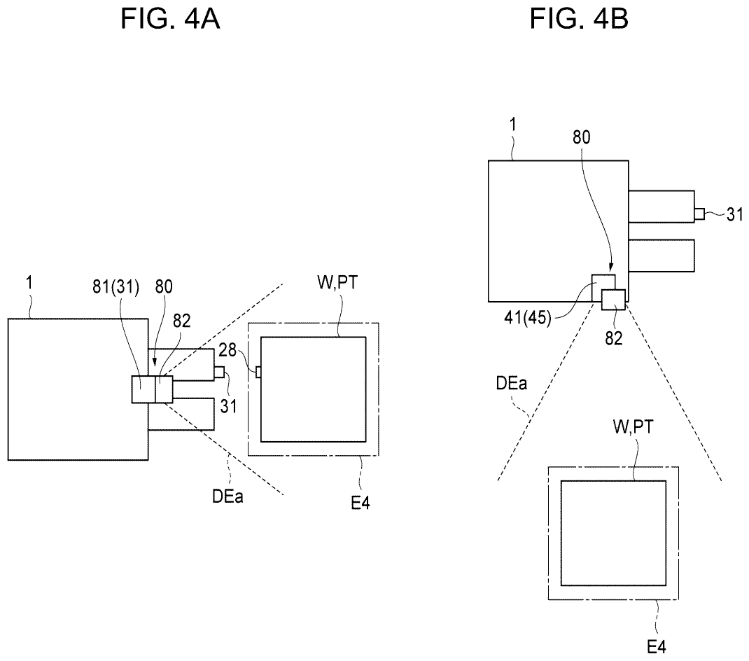

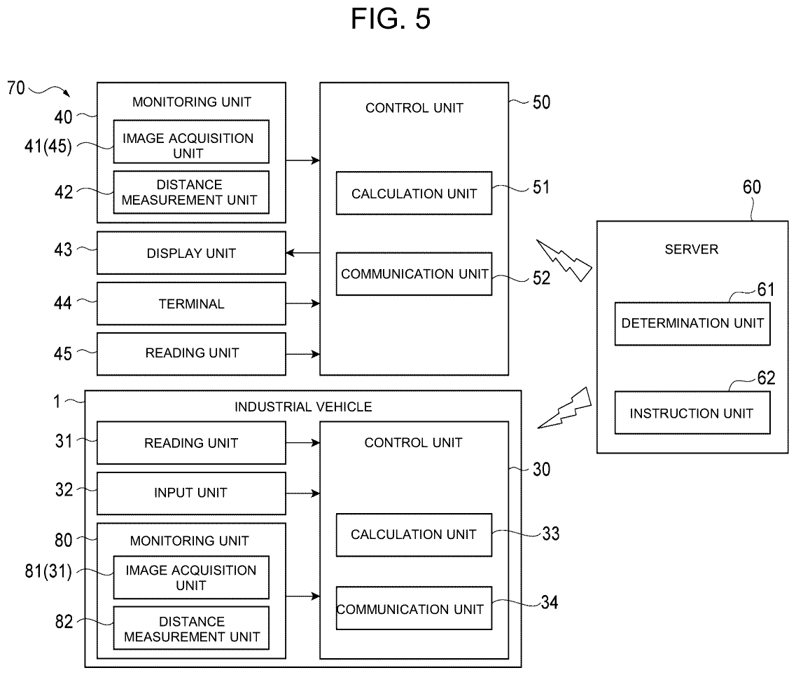

Next, the configuration of the cargo handling system 100 will be described with reference to FIGS. 2 to 5. FIG. 2 is a plan view of the cargo handling system 100. FIG. 3 is a front view of the cargo handling system 100. FIG. 4 is a schematic view of the industrial vehicle 1. FIG. 5 is a block diagram of the cargo handling system 100. As illustrated in FIGS. 2 and 3, the cargo handling system 100 includes the above-mentioned industrial vehicle 1, a transport vehicle 20, a work site 110, a ground equipment 70, and a server 60. The cargo handling system 100 is a system in which the industrial vehicle 1 performs cargo handling operation to the transport vehicle 20.

As illustrated in FIG. 5, the industrial vehicle 1 includes a control unit 30, a reading unit 31, an input unit 32, and a monitoring unit 80. The control unit 30 is a device that controls the entire industrial vehicle 1. The control unit 30 includes a CPU, a RAM, a ROM, input/output interfaces, and the like. The control unit 30 includes a calculation unit 33 that performs various types of calculations, and a communication unit 34 that performs communication. The communication unit 34 communicates with the ground equipment 70 and the server 60. The reading unit 31 is a device capable of reading various types of information. The reading unit 31 reads identification information from identification information providers 27, 28 which will be described later. The reading unit 31 may include an image acquisition unit such as a camera, an RFID reader that reads an RFID tag, and the like. As the image acquisition unit for the reading unit 31, an image acquisition unit 81 of the monitoring unit 80 described below may be used. A position of the reading unit 31 in the industrial vehicle 1 is not limited to any particular position as long as the identification information providers 27, 28 can be read by the reading unit 31. The RFID reader of the reading unit 31 may be provided at a position where it is easy to read the identification information provider 28 of a pallet PT, such as the forks 13 (see FIG. 4). The input unit 32 is a device on which various types of information can be input to the industrial vehicle 1. The industrial vehicle 1 includes various types of switches, a touch panel, and the like as the input unit 32. The monitoring unit 80 will be described in detail later.

As illustrated in FIG. 2, the transport vehicle 20 includes a travel unit 21 and a loading platform 22 on which cargos W are loaded. In the present embodiment, a truck is used as the transport vehicle 20. As illustrated in FIG. 3, the loading platform 22 includes a floor portion 23, a ceiling portion 24, and a pair of wings 26. The pair of wings 26 opens and closes side portions of the loading platform 22. The wings 26 open and close using the ceiling portion 24 as a hinge. The pallet PT on which the cargo W is placed is loaded on the floor portion 23 of the loading platform 22.

The identification information provider 27 that provides identification information for identifying the transport vehicle 20 is provided in the loading platform 22. The identification information provider 28 that provides identification information for identifying the cargo W placed on the pallet PT is provided in the pallet PT. For example, a medium that can be read based on an image may be used as the identification information providers 27, 28. For example, the identification information providers 27, 28 may be two-dimensional codes. For example, as the two-dimensional codes, a QR code (registered trademark), a bar code, or the like may be used. Alternatively, the identification information providers 27, 28 may be a medium that can be read by a reading device. For example, an RFID tag or the like may be used as the medium that can be read by the reading device. The identification information providers 27, 28 are read by a reading unit 31 (see FIG. 5) provided on the industrial vehicle 1 or a reading unit 45 of the ground equipment 70.

The identification information provider 27 of the transport vehicle 20 may include, as identification information, information of where the transport vehicle 20 comes from, information of where the transport vehicle 20 goes to, information of a driver, and the like. The identification information provider 28 of the pallet PT may include, as identification information, information of a shipper, a type, and a weight of the cargo W, information of sizes of pallet holes of the pallet PT, information of where the cargo W and the pallet PT come from, information of where the cargo W and the pallet PT go to, and the like.

As illustrated in FIG. 2, the work site 110 has a stopping area E1, a waiting place E2, a home position E3, and a transition position E4. The stopping area E1 is an area where the transport vehicle 20 stops. The industrial vehicle 1 performs unloading of the cargo W loaded on the loading platform 22 of the transport vehicle 20 having stopped in the stopping area E1. Furthermore, the industrial vehicle 1 performs loading of the cargo W onto the loading platform 22 of the transport vehicle 20 having stopped in the stopping area E1. In the following explanation, when description is made simply using a “cargo handling operation,” the cargo handling operation indicates both an “unloading operation” and a “loading operation” without distinction. The waiting place E2 is an area where the transport vehicle 20 waits. At the waiting place E2, the transport vehicle 20 waits until the stopping area E1 becomes available for stopping. The home position E3 is an area where the industrial vehicle 1 waits while the industrial vehicle 1 is not performing the cargo handling operation.

The transition position E4 is a position where one process transitions to another process in the cargo handling operation. A subsequent process is performed for the pallet PT and the cargo W, which are placed at the transition position E4 in the previous process. Here, an unloading process in which the pallet Pt and the cargo W are unloaded from the transport vehicle 20 is performed. After an industrial vehicle 1A unloads the pallet PT and the cargo W from the transport vehicle 20, the industrial vehicle 1A places the pallet PT and the cargo W at the transition position E4. A vehicle 1B performs a transporting process in which the pallet PT and the cargo W placed at the transition position E4 are lifted and transported from the transition position E4 to a storage position. The vehicle 1B, which performs the transporting process, may be an industrial vehicle such as a forklift truck, or may be other types of a vehicle such as an AMR. The vehicle 1B corresponds to another vehicle in the present embodiment. Furthermore, the industrial vehicle 1A may place the pallet PT directly at the transition position E4, or may hand over the pallet PT and the cargo W to the vehicle 1B, such as the AMR, waiting at the transition position E4. In this way, the unloading process transitions to the transporting process at the transition position E4. In addition, once the industrial vehicle 1A, which performs the unloading process, places the pallet PT and the cargo W at the transition position E4, the industrial vehicle 1A may return to unloading of another pallet PT and another cargo W, or may wait until the transition position E4 becomes available. In a state where there are a pallet PT and a cargo W previously placed at the transition position E4, the industrial vehicle 1A, which performs the unloading process, waits to place the pallet PT and the cargo W at the transition position E4 until the previous pallet PT and the previous cargo W are transported. In a state where the pallet PT and the cargo W are placed at the transition position E4, the vehicle 1B, which performs the transporting process, lifts up and transports the pallet PT and the cargo W. In a state where the pallet PT and the cargo W are not placed at the transition position E4, the vehicle 1B, which performs the transporting process, waits until the pallet PT and the cargo W are placed.

Furthermore, at the transition position E4, a loading process in which the pallet PT and the cargo W are loaded onto the transport vehicle 20 is performed. Once the transporting process in which the vehicle 1B places the pallet PT and the cargo W from the storage position to the transition position E4 is performed, the industrial vehicle 1A lifts the pallet PT and the cargo W from the transition position E4 and loads them onto the loading platform 22 of the transport vehicle 20.

The ground equipment 70 is equipment provided at a position different from the industrial vehicle 1 and the transport vehicle 20 in the work site 110. That is, the ground equipment 70 is not mounted on the industrial vehicle 1 or the transport vehicle 20, but is provided as a device on a facility side. The ground equipment 70 includes monitoring units 40 and a control unit 50.

The control unit 50 is a device that controls the entire ground equipment 70. The control unit 50 includes a CPU, a RAM, a ROM, input/output interfaces, and the like. The control unit 50 may be disposed at any position in the work site 110, which does not disturb the cargo handling operation. As illustrated in FIG. 5, the control unit 50 includes a calculation unit 51 that performs various types of calculations, and a communication unit 52 that performs communication. The communication unit 52 can communicate with the industrial vehicle 1 and the server 60.

As illustrated in FIG. 5, the ground equipment 70 includes a display unit 43 and a terminal 44, and the reading unit 45. The display unit 43 is a device that receives display information from the control unit 50 to perform display in the work site 110. The display unit 43 may be a monitor, a touch panel, or the like. The display unit 43 only needs to be provided at the position of the control unit 50 (see FIGS. 2 and 3), or only needs to be provided at any position in the work site 110. The display unit 43 displays information such as whether the cargo handling operation can be started, temporary halt of the cargo handling operation, or ending of the cargo handling operation. The display unit 43 functions as a notification unit that provides information in the work site 110. The terminal 44 is a device on which an operator can input information in the work site 110. The terminal 44 transmits input information to the control unit 50. The terminal 44 may be a dedicated operation terminal, a tablet, a smartphone, or the like. The terminal 44 can accept button operations to indicate an intention to start an automated operation or an intention to resume an automated operation. Examples of buttons that terminal 44 can accept include a “Start unloading operation” button for starting the unloading operation, a “Start loading operation” button for starting the loading operation, a “Loading operation” switch button for switching to the loading operation, an “Unloading operation” switch button for switching to the unloading operation, and a “Operation completed” button for indicating that the cargo handling operation is complete. The terminal 44 only needs to be provided at the position of the control unit 50 (see FIGS. 2 and 3), or only needs to be provided at any position in the work site 110.

The reading unit 45 is a device capable of reading various types of information. The reading unit 45 reads identification information from the identification information providers 27, 28. The reading unit 45 may include an image acquisition unit such as a camera, an RFID reader that reads an RFID tag. As the image acquisition unit for the reading unit 45, an image acquisition unit 41 of each of the monitoring units 40 described below may be used. A position of the reading unit 45 in the industrial vehicle 1 is not limited to any particular position as long as the identification information providers 27, 28 can be read by the reading unit 45. The RFID reader of the reading unit 45 may be provided in a manner that allows the operator on the work site 110 to carry around, for example.

Next, the monitoring units 40 of the ground equipment 70 and the monitoring unit 80 of the industrial vehicle 1 will be described. The monitoring units 40 of the ground equipment 70 monitor at least one of the loading platform 22 of the transport vehicle 20 having stopped in the stopping area E1 and a surrounding area of the loading platform 22 having stopped in the stopping area E1. The monitoring units 40 each includes the image acquisition unit 41 that acquires an image, and a distance measurement unit 42 that measures a distance to a target object. The monitoring unit 40 has a monitoring area DE. The monitoring area DE includes the stopping area E1, the waiting place E2, and the home position E3. In the present embodiment, the cargo handling system 100 has a pair of monitoring units 40. One of the monitoring units 40 monitors one side of the transport vehicle 20. The other of the monitoring units 40 monitors the other side of the transport vehicle 20. Although positions of the monitoring units 40 are not limited to any particular positions, the monitoring units 40 are disposed at positions spaced above the ground so as to monitor the sides of the transport vehicle 20 entirely and the surroundings of the transport vehicle 20, as illustrated in FIG. 3. The image acquisition unit 41 is a device that acquires an image within the monitoring area DE. The image acquisition unit 41 is, for example, a camera. The distance measurement unit 42 is a device that measures a distance to the target object existing in the monitoring area DE. The distance measurement unit 42 is, for example, a 3D LiDAR, or the like.

Furthermore, the monitoring units 40 of the ground equipment 70 may monitor a state of the transition position E4. The monitoring units 40 may monitor whether or not the pallet PT and the cargo W are placed at the transition position E4. The monitoring units 40 may also monitor whether or not an obstacle other than the pallet PT and the cargo W is present at the transition position E4. Examples of the target object include a person such as an operator and an object other than the pallet PT and the cargo W.

As illustrated in FIGS. 4 and 5, the monitoring unit 80 of the industrial vehicle 1 includes an image acquisition unit 81 that acquires an image, and a distance measurement unit 82 that measures a distance to the target object. The monitoring unit 80 has a monitoring area DEa. As illustrated in FIG. 4A, the monitoring unit 80 may be disposed on a front side of the industrial vehicle 1. In this case, the monitoring area DEa is set in front of the industrial vehicle 1. As illustrated in FIG. 4B, the monitoring unit 80 may be disposed on a lateral surface side of the industrial vehicle 1. In this case, the monitoring area DEa is set toward the lateral side of the industrial vehicle 1. The configuration of the monitoring unit 80 is not limited to the configuration illustrated in FIGS. 4A and 4B. It is noted that both the image acquisition unit 81 and the distance measurement unit 82 do not have to be provided, and one of the image acquisition unit 81 and the distance measurement unit 82 may be omitted. In addition, positions of the image acquisition unit 81 and the distance measurement unit 82 are not particularly limited. In addition, the image acquisition unit 81 and the distance measurement unit 82 may face different directions. For example, the distance measurement unit 82 may be provided at the rear of the industrial vehicle 1 to monitor an obstacle behind the industrial vehicle 1. The image acquisition unit 81 and the distance measurement unit 82 may be used selectively depending on the target object to be monitored. For example, the image acquisition unit 81 may detect the pallet PT, and the distance measurement unit 82 may detect an obstacle such as a person.

The monitoring unit 80 of the industrial vehicle 1 may monitor the state at the transition position E4. The monitoring unit 80 may monitor whether or not the pallet PT and the cargo W are placed at the transition position E4. The monitoring unit 80 may also monitor whether or not an obstacle other than the pallet PT and the cargo W is present at the transition position E4. As illustrated in FIG. 4A, when the monitoring unit 80 is provided on the front side of the industrial vehicle 1, the monitoring unit 80 can monitor the transition position E4 in front. As illustrated in FIG. 4B, when the monitoring unit 80 is provided on the lateral surface side of the industrial vehicle 1, the monitoring unit 80 can monitor the transition position E4 in the lateral direction of the industrial vehicle 1

The transition position E4 may be monitored by both of the monitoring units 40 and the monitoring unit 80, or by one of the monitoring units 40 and the monitoring unit 80. When the monitoring units 40 of the ground equipment 70 monitor the transition position E4, the monitoring unit 80 of the industrial vehicle 1 may be omitted.

The server 60 performs various types of information processing in the cargo handling system 100 and accumulates various types of information. The server 60 may be provided in the work site 110 or may be provided outside the work site 110. The server 60 may be a cloud server, or the like. As illustrated in FIG. 5, the server 60 includes a determination unit 61 and an instruction unit 62. The determination unit 61 determines a state of the loading platform 22 and a state of the surrounding area of the loading platform 22 based on the information acquired by the monitoring units 40. The determination unit 61 makes the determination using artificial intelligence. The artificial intelligence is trained based on data in which past monitoring information from the monitoring units 40 is linked with a state corresponding to the past monitoring information. For example, the artificial intelligence is trained from image data acquired by the monitoring units 40. The instruction unit 62 transmits an instruction to the industrial vehicle 1 based on a result of determination by the determination unit 61. There is no particular limitation as to where the determination unit 61 and the instruction unit 62 are provided in the cargo handling system 100, and the determination unit 61 and the instruction unit 62 may be provided in the control unit 50, or in the ground equipment 70 other than the control unit 50.

The determination unit 61 makes a determination related to the cargo handling operation. Specifically, the determination unit 61 determines whether or not the transport vehicle 20 is present in the stopping area E1 and the waiting place E2. The determination unit 61 determines the position of the transport vehicle 20 in each of the areas E1, E2. The determination unit 61 determines whether the wings 26 of the transport vehicle 20 are open or closed. The determination unit 61 determines whether or not there is an obstacle on the loading platform 22. The determination unit 61 determines a height of the loading platform of the transport vehicle 20. In the following description, the determination related to a state of the transport vehicle 20 may be referred to as “determination of the state of the transport vehicle 20.” In addition, the determination unit 61 determines whether or not an obstacle (a person such as an operator) is present in the surrounding area of the transport vehicle 20. For these determination contents, the determination unit 61 may make a determination using both of the image data and the distance data, but may make a determination only from the image data using artificial intelligence or the like. Based on these results of determination, the instruction unit 62 issues an instruction for operation contents of the cargo handling operation to the industrial vehicle 1. The instruction unit 62 issues an instruction regarding positions where cargos are placed, stowage, an order of loading and unloading, the number of cargos, and the like. Furthermore, when the determination unit 61 determines that a person is present in the surrounding area of the loading platform 22, the instruction unit 62 transmits a stop instruction to the industrial vehicle 1. The determination unit 61 also determines information relating to a state of the cargo handling operation. For example, the determination unit 61 determines whether or not the cargo handling operation can be started and whether or not the cargo handling operation has been completed.

The determination unit 61 may make a determination regarding the cargo handling operation based on the identification information read by the reading units 31, 45. The instruction unit 62 may transmit an instruction to the industrial vehicle 1A based on the identification information read by the reading units 31, 45. The determination unit 61 may determine a fork width of the forks 13 of the industrial vehicle 1A and the cargo handling position based on at least one of the identification information and the monitoring results by the monitoring units 40, 80, and may also determine whether the unloading operation is to be performed or the loading operation is to be performed. The instruction unit 62 may issue an instruction for the unloading operation or the loading operation based on the fork width of the industrial vehicle 1A and the cargo handling position, which are determined based on at least one of the identification information and the monitoring results by the monitoring units 40, 80. Accordingly, the industrial vehicle 1 performs one of the unloading operation or the loading operation based on the fork width and the cargo handling position of the industrial vehicle 1A, which are determined based on at least one of the identification information and the monitoring results by the monitoring units 40, 80.

The determination unit 61 may determine that unloading can be performed when it is determined that the cargo W is present on the loading platform 22 of the transport vehicle 20 in the work site 110. The determination unit 61 determines whether the cargo W is present on the loading platform 22 of the transport vehicle 20 in the work site, based on the identification information read by the reading units 31, 45. The instruction unit 62 may issue an instruction to the display unit 43 of the ground equipment 70 to display information indicating that unloading can be performed. As a result, when it is determined that the cargo W is present on the loading platform 22 of the transport vehicle 20 in the work site 110, the display unit 43 provides information indicating that unloading can be performed. When the loading operation instruction is input on the terminal 44 while the display unit 43 provides information indicating that unloading can be performed, the instruction unit 62 may issue an instruction to at least one of the industrial vehicle 1A and the vehicle 1B to detect a pallet PT having the identification information provider 28 providing the identification information of a loading target from the storage position. The determination unit 61 may determine that loading can be performed when no cargo W is present on the loading platform 22 of the transport vehicle 20 in the work site 110. The instruction unit 62 may issue an instruction to the display unit 43 of the ground equipment 70 to display information indicating that loading can be performed. As a result, when it is determined that no cargo W is present on the loading platform 22 of the transport vehicle 20 in the work site 110, the display unit 43 provides information indicating that loading can be performed. In addition, the instruction unit 62 may issue an instruction to at least one of the industrial vehicle 1A and the vehicle 1B to detect a pallet PT having the identification information provider 28 providing the identification information of the loading target from the storage position.

In an example illustrated in FIG. 2, the instruction unit 62 issues an instruction to the vehicle 1B to detect the pallet PT having the identification information provider 28 of the loading target from the storage position. The identification information of the loading target may include, for example, destination information. For example, it is assumed that there are a pallet PT including the identification information of “Destination A”, a pallet PT including the identification information of “Destination B”, a pallet PT including the identification information of “Destination C” in the storage position. When the identification information of the loading target is “Destination A”, the vehicle 1B detects the pallet PT having the identification information of “Destination A”. The vehicle 1B places the pallet PT including the identification information of “Destination A” at the transition position E4. At this time, the industrial vehicle 1 may read the identification information of the transition position E4 with the reading unit 31 and check if the destination is “Destination A”, and then perform the loading operation. In this way, the destination of the pallet PT can be double-checked using the reading unit 31. The industrial vehicle 1 itself may detect the pallet PT having the identification information provider 28 of the loading target in the storage position.

For example, the determination unit 61 may determine a destination based on the identification information of the pallet PT. The instruction unit 62 issues an instruction for a place where the cargo W is to be placed. The determination unit 61 determines a shape of the pallet PT based on sizes of pallet holes included in the identification information, and the instruction unit 62 issues an instruction indicating an optimal fork width. The server 60 may manage information regarding which and how many cargos W are loaded on which transport vehicle 20 based on the identification information of the transport vehicle 20 and the identification information of the pallets PT. The determination unit 61 may determine which transport vehicle 20 is stopped in the stopping area E1 based on the identification information of the transport vehicle 20, and identify the cargos W from the information managed by the server 60. Then, the instruction unit 62 issues an instruction for an unloading destination and causes the industrial vehicle 1 to perform the automated operation. The instruction unit 62 also issues an instruction relating to a designated pallet, a location of loading, a loading order, and the number of pallets to cause the industrial vehicle 1 to perform the automated operation.

The determination unit 61 may determine whether or not the subsequent process can be performed based on the information acquired by the monitoring units 40, 80. The determination unit 61 determines that the subsequent process can be performed based on arrival of the target object at the transition position E4. When the pallet PT as the target object arrives at the transition position E4, the determination unit 61 determines that the vehicle 1B, which performs the transporting process, can perform the transporting process which is performed subsequently to the unloading process. At this time, the instruction unit 62 issues an instruction to the vehicle 1B to automatedly perform the transporting process for transporting the pallet PT and the cargo W at the transition position E4. A timing for performing the transporting process subsequently to the unloading process may be based on the industrial vehicle 1A reporting to the server 60 that unloading has been completed. The determination unit 61 may determine that the industrial vehicle 1A, which performs the unloading process, can perform the subsequent unloading process, which is performed subsequently to the transporting process, when the vehicle 1B (e.g., AMR) as the target object reaches the transition position E4. At this time, the instruction unit 62 causes the industrial vehicle 1A to operate automatedly by issuing an instruction to perform the unloading process in which the industrial vehicle 1A unloads the pallet PT and the cargo W from the transport vehicle 20 and hands over the pallet PT and the cargo W to the vehicle 1B such as an AMR at the transition position E4. Furthermore, when the pallet PT as the target object has reached the transition position E4, the determination unit 61 determines that the industrial vehicle 1A can perform the loading process that is performed subsequently to the transporting process.

The determination unit 61 may determine that the subsequent process can be performed based on removable of the target object having been present at the transition position E4 from the transition position E4. When the pallet PT, as the target object, is removed from the transition position E4, the determination unit 61 determines that the industrial vehicle 1A, which performs the unloading process/loading process, can perform the unloading process/loading process subsequent to the transporting process. When an obstacle, as the target object, is removed from the transition position E4, the determination unit 61 determines that the industrial vehicle 1A can perform the subsequent unloading process/loading process after the transporting process. At this time, the instruction unit 62 issues an instruction to the industrial vehicle 1A to automatedly perform the subsequent unloading process/loading process for unloading the next pallet PT and the next cargo W from the transport vehicle 20.

The determination unit 61 may determine whether or not the target object is present at the transition position E4 by analyzing the image information and the distance information from the monitoring units 40, 80. In this case, the determination unit 61 may store the position information of the transition position E4 and the like. However, if the monitoring units 40, 80 themselves each include a calculation unit, the monitoring units 40, 80 can determine whether the target object is the pallet PT or an obstacle, and determine the presence or absence of the pallet PT or the obstacle. In this case, the monitoring units 40, 80 may store the position information of the transition position E4 and the like. The monitoring units 40, 80 may generate and transmit determination information, indicating a detail of the target object and whether or not the target object is present, to the control units 50, 30. In this case, the determination unit 61 of the server 60 can make a determination by only referring to the determination information, so that a calculation load can be reduced. In addition, when the determination of whether or not the subsequent process can be performed is made by monitoring the transition position E4 by the monitoring units 40, 80, only the determination information, instead of the image information and the distance information, is transmitted to the control units 50, 30 (and hence the server 60). As a result, a communication load may be reduced.

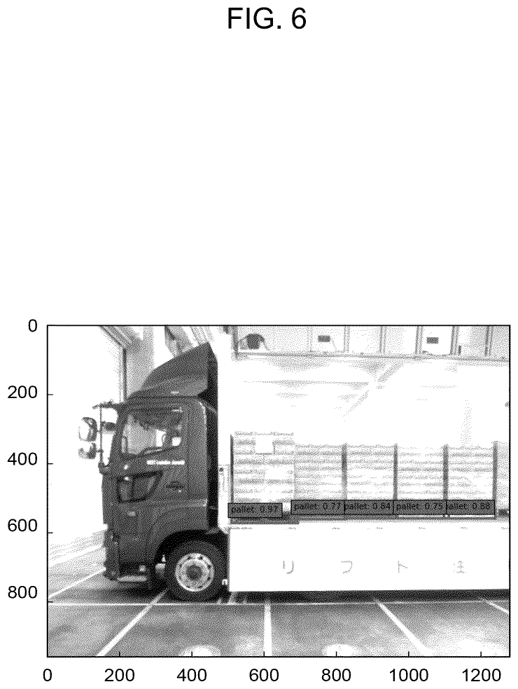

For example, as shown in FIG. 6, the determination unit 61 determines the number of pallets on the loading platform 22 from image data of the loading platform 22 sent from the monitoring unit 40 by a known technique using trained artificial intelligence. The instruction unit 62 transmits the number of the pallets determined by the determination unit 61 to the industrial vehicle 1. This allows the industrial vehicle 1, which performs the automated operation, to determine an operation amount for loading and unloading. Furthermore, if the pallets PT are stacked vertically, the determination unit 61 may determine whether an upper pallet PT or a lower pallet PT is to be unloaded or loaded. In addition, by using a technique for determining the pallet PT by artificial intelligence, the determination unit 61 may determine the presence or absence of a person, the presence or absence of the transport vehicle 20, the position of the transport vehicle 20, the height of the loading platform, and the like, based on the image data.

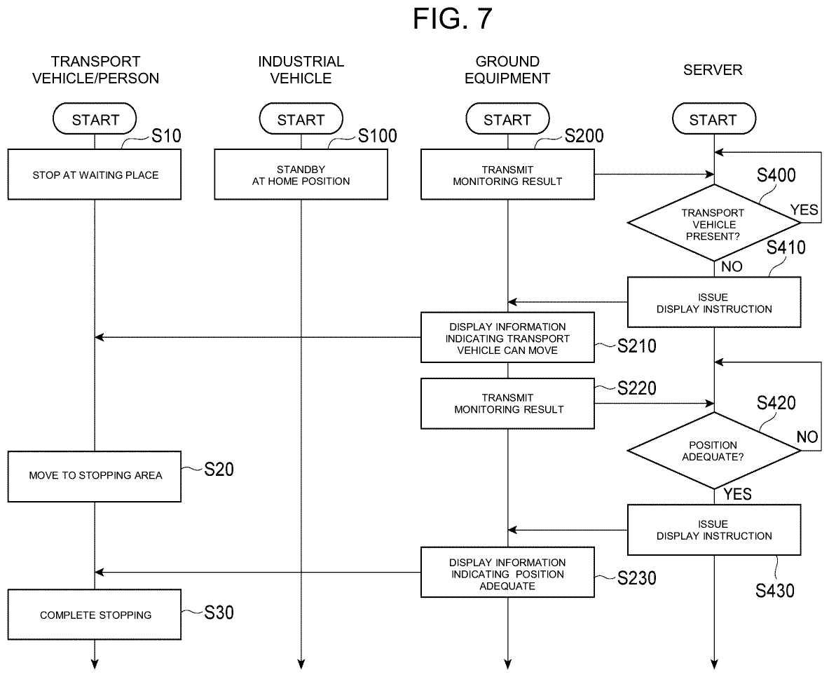

Next, an example of processing executed by the cargo handling system 100 will be described with reference to FIGS. 7 to 23. In the flowchart, operations of “TRANSPORT VEHICLE/PERSON/ANOTHER VEHICLE,” “INDUSTRIAL VEHICLE,” “GROUND EQUIPMENT,” and “SERVER” are listed in parallel. Firstly, details of processing when the cargo handling operation (the loading operation or the unloading operation) is performed by the automated operation of the industrial vehicle 1 (industrial vehicle 1A in FIG. 2) will be described with reference to FIGS. 7 to 13.

At a start of processing in FIG. 7, the transport vehicle 20 stops at the waiting place E2 (step S10). The industrial vehicle 1 is on standby at the home position E3 (step S100). The monitoring unit 40 of the ground equipment 70 transmits a monitoring result to the server 60 (step S200). The determination unit 61 of the server 60 determines whether or not the transport vehicle 20 is present in the stopping area E1 (step S400). When the determination unit 61 determines that the transport vehicle 20 is present, the determination unit 61 performs step S400 again. When the determination unit 61 determines that the transport vehicle 20 is not present, the instruction unit 62 issues a display instruction to the display unit 43 of the ground equipment 70 (step S410). The display unit 43 displays information for a driver of the transport vehicle 20, indicating that the transport vehicle 20 can move to the stopping area E1 (step S210). When the determination unit 61 determines in step S400 that the transport vehicle 20 is in the stopping area E1, the display unit 43 may display information indicating that the transport vehicle 20 cannot move to the stopping area E1. The transport vehicle 20 moves to the stopping area E1 at any timing after the information is displayed (step S20).

The monitoring unit 40 transmits the monitoring result to the server 60 (step S220). The determination unit 61 determines whether the position of the transport vehicle 20 in the stopping area E1 is adequate (step S420). When the determination unit 61 determines that the position of the transport vehicle 20 is not adequate, the determination unit 61 performs step S420 again. When the determination unit 61 determines that the position of the transport vehicle 20 is adequate, the instruction unit 62 issues a display instruction to the display unit 43 (step S430). The display unit 43 displays information for the driver of the transport vehicle 20, indicating that the position of the transport vehicle 20 in the stopping area E1 is adequate (step S230). When the determination unit 61 determines in step S420 that the position of the transport vehicle 20 is not adequate, the display unit 43 may display information, indicating that the position of the transport vehicle 20 is not adequate. After the information indicating that the position of the transport vehicle 20 in the stopping area E1 is adequate is displayed, stopping of the transport vehicle 20 is completed (step S30)

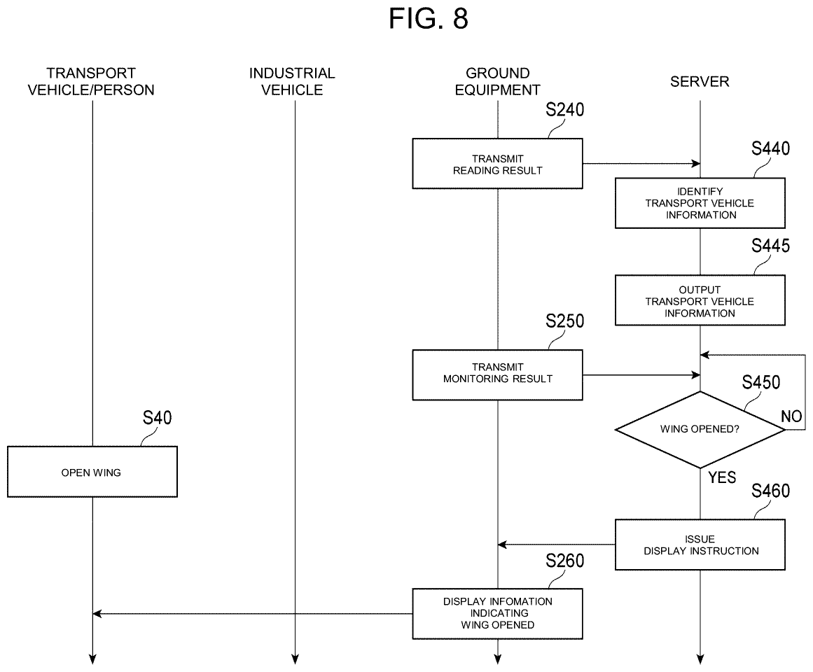

As shown in FIG. 8, the reading unit 45 of the ground equipment 70 reads the identification information of the identification information provider 27 of the transport vehicle 20, and transmits a reading result to the server 60 (step S240). The determination unit 61 identifies transport vehicle information related to the transport vehicle 20 based on the read result (step S440). The instruction unit 62 issues an instruction to the devices in the system to output the transport vehicle information (step S445). The transport vehicle information may include, for example, information on “where the transport vehicle 20 is from” and “destination of the transport vehicle 20.” The instruction unit 62 outputs the transport vehicle information to an operator or a driver by causing the display unit 43 of the ground equipment 70 to display the transport vehicle information. The transport vehicle 20 opens the wings 26 at any timing after the transport vehicle 20 is stopped (step S40). The monitoring unit 40 transmits the monitoring result to the server 60 (step S250). The determination unit 61 determines whether or not the wings 26 of the transport vehicle 20 are opened (step S450). When the determination unit 61 determines that the wings 26 are closed, the determination unit 61 performs step S450 again. When the determination unit 61 determines that the wings 26 are opened, the instruction unit 62 issues a display instruction to the display unit 43 of the ground equipment 70 (step S460). The display unit 43 displays information for the driver of the transport vehicle 20, indicating that the wings 26 are opened (step S260). If the determination unit 61 determines in step S450 that the wings 26 are closed, the display unit 43 may display information, indicating that the wings 26 are closed.

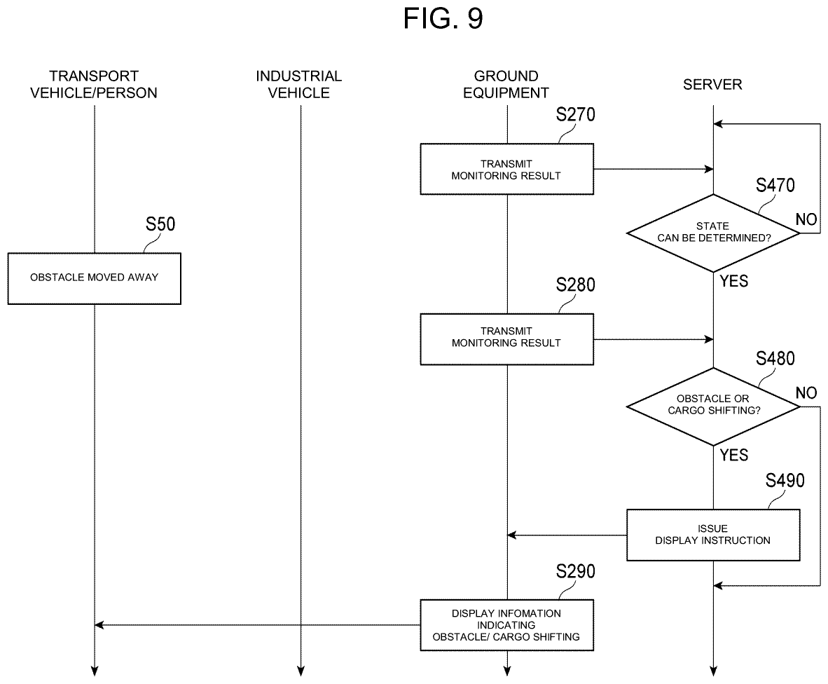

As shown in FIG. 9, the monitoring unit 40 transmits a monitoring result (step S270). The determination unit 61 makes a determination on various types of conditions relating to the determination of the state of the transport vehicle 20, and on whether or not the state of the transport vehicle 20 can be determined (step S470). Here, the determination unit 61 determines the height of the platform 22 from the ground, the number of the pallets and their sizes on the loading platform 22, the presence or absence of the pallets and their sizes at the transition position, the position of the pallets, and whether or not there is cargo shifting. An obstacle such as a person moves away from the surrounding area of the transport vehicle 20 at any time after the wings 26 are opened (step S50). When the determination unit 61 determines that the state of the transport vehicle 20 cannot be determined, the determination unit 61 repeats step S470 until the state of the transport vehicle 20 can be determined. The monitoring unit 40 transmits a monitoring result to the server 60 (step S280). The determination unit 61 determines whether or not an obstacle is present in the surrounding area of the transport vehicle 20 and whether or not there is a possibility of cargo shifting (step S480). Here, the determination unit 61 determines whether there is a person, another forklift truck, an AMR, an obstacle, or cargo shifting. When the determination unit 61 determines that an obstacle is present or there is a possibility of cargo shifting, the instruction unit 62 issues a display instruction to the display unit 43 of the ground equipment 70 (step S490). The display unit 43 displays information for the driver of the transport vehicle 20, indicating that an obstacle is present or there is a possibility of cargo shifting (step S290). After the display in step S290, waiting may be performed until the obstacle moves away and there is no longer possibility of cargo shifting by performing step S480 again. It is noted that step S490 is omitted when the determination unit 61 determines in step S480 that no obstacle is present and there is no possibility of cargo shifting.

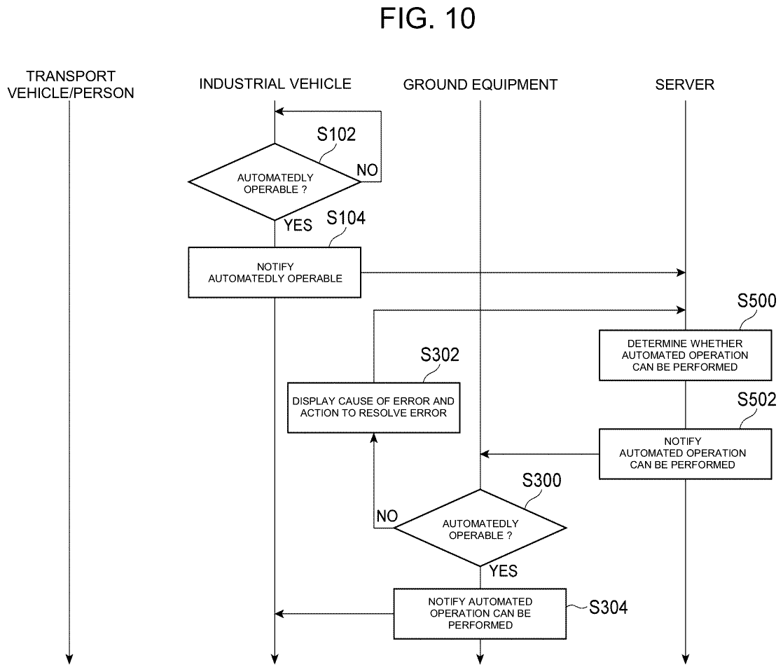

As shown in FIG. 10, the industrial vehicle 1 determines whether or not the industrial vehicle 1 itself is in an automatedly operable state in which the industrial vehicle 1 can perform the automated operation (step S102). When the industrial vehicle 1 is not in the automatedly operable state, step S102 is performed again. When the industrial vehicle 1 is in the automatedly operable state, the industrial vehicle 1 notifies the server 60 as such (step S104). Meanwhile, the determination unit 61 determines whether or not the industrial vehicle 1 can perform the automated operation (step S500). After receiving notification of step S104, the determination unit 61 determines that the industrial vehicle 1 can perform the automated operation in step S500. At this time, the determination unit 61 notifies the ground equipment 70 of the result of the determination of whether or not the automated operation can be performed (step S502). When the determination unit 61 determines that the industrial vehicle 1 can perform the automated operation, the determination unit 61 determines whether the industrial vehicle 1 performs the unloading operation or the loading operation. In the following description, it is assumed that it is determined that the unloading operation is to be performed due to the presence of the pallet PT on the loading platform 22 of the transport vehicle 20. However, when no pallet PT is present on the loading platform 22, the determination unit 61 may determine that the loading operation is to be performed.

The ground equipment 70 refers to the determination result notified in step S502 and determines whether or not the industrial vehicle 1 can perform the automated operation (step S300). In addition, when the industrial vehicle 1 cannot perform the automated operation, the ground equipment 70 determines a cause of an error that prevents the industrial vehicle 1 to perform the automated operation and an action to be taken to resolve the error. If the ground equipment 70 determines in step S300 that the automated operation cannot be performed, a cause of an error and an action to be taken to resolve the error are displayed on the display unit 43 (step S302). After the display of step S302, the server 60 repeats the processing from step S500. If the ground equipment 70 determines in step S300 that the automated operation can be performed, the ground equipment 70 notifies the industrial vehicle 1 that the automated operation can be performed (step S304). At this time, the ground equipment 70 transmits data required for the unloading operation to the industrial vehicle 1.

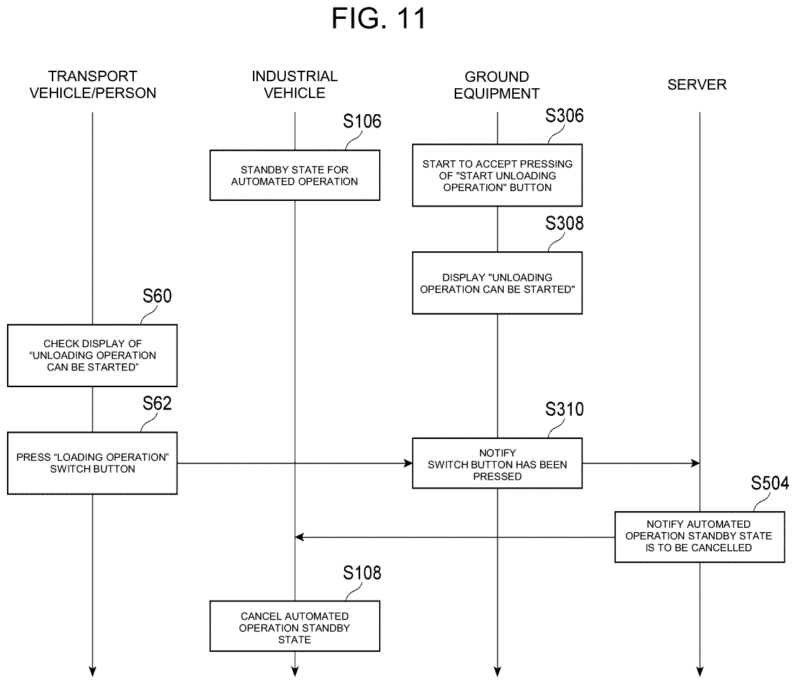

As shown in FIG. 11, when the industrial vehicle 1 receives the notification in step S304, the industrial vehicle 1 becomes in a standby state for the automated operation (step S106). The ground equipment 70 prepares for a start of the automated operation by displaying a “Start unloading operation” button on the terminal 44 and starting to accept pressing of the button (step S306). In addition, the ground equipment 70 displays “Unloading operation can be started” on the display unit 43 (step S308). The operator checks the display of “Unloading operation can be started” at any time after this processing (step S60). Here, it is assumed that the operation to be performed in the work site 100 is not the unloading operation but the loading operation. At this time, the operator intends to perform the loading operation, not the unloading operation. Therefore, the operator operates the terminal 44 and presses a switch button to switch to “Loading operation” (Step S62). When the button is pressed, the ground equipment 70 notifies the server 60 that such a switch button has been pressed (step S310). With the cargo handling operation switched, the server 60 notifies the industrial vehicle 1 that the automated operation standby state is to be cancelled (step S504). Thus, the industrial vehicle 1 cancels the automated operation standby state (S108).

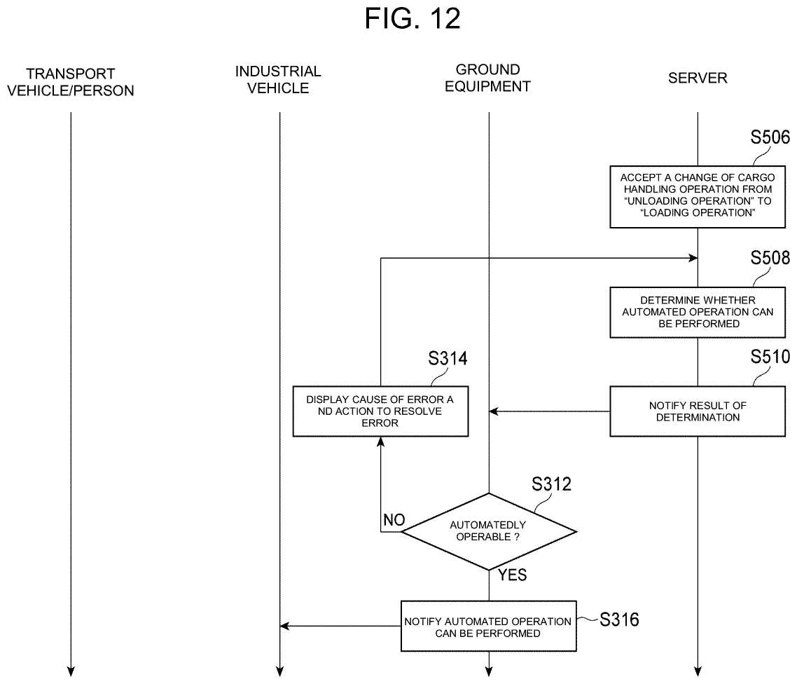

As shown in FIG. 12, the server 60 accepts a change of the cargo handling operation from the “Unloading operation” to the “Loading operation.” (step S506). The determination unit 61 determines whether or not the industrial vehicle 1 can perform the automated operation (step S508). The determination unit 61 notifies the ground equipment 70 of the result of the determination of whether or not the automated operation can be performed (step S510). The ground equipment 70 refers to the determination result notified in step S510 and determines whether or not the industrial vehicle 1 can perform the automated operation (step S312). In addition, when the industrial vehicle 1 cannot perform the automated operation, the ground equipment 70 determines a cause of an error that prevents the industrial vehicle 1 to perform the automated operation and an action to be taken to resolve the error. If the ground equipment 70 determines in step S312 that the automated operation cannot be performed, a cause of an error and an action to be taken to resolve the error are displayed on the display unit 43 (step S314). After the display of step S314, the server 60 repeats the processing from step S508. If the ground equipment 70 determines in step S312 that the automated operation can be performed, the ground equipment 70 notifies the industrial vehicle 1 that the automated operation can be performed (step S316). At this time, the ground equipment 70 transmits data required for the loading operation to the industrial vehicle 1.

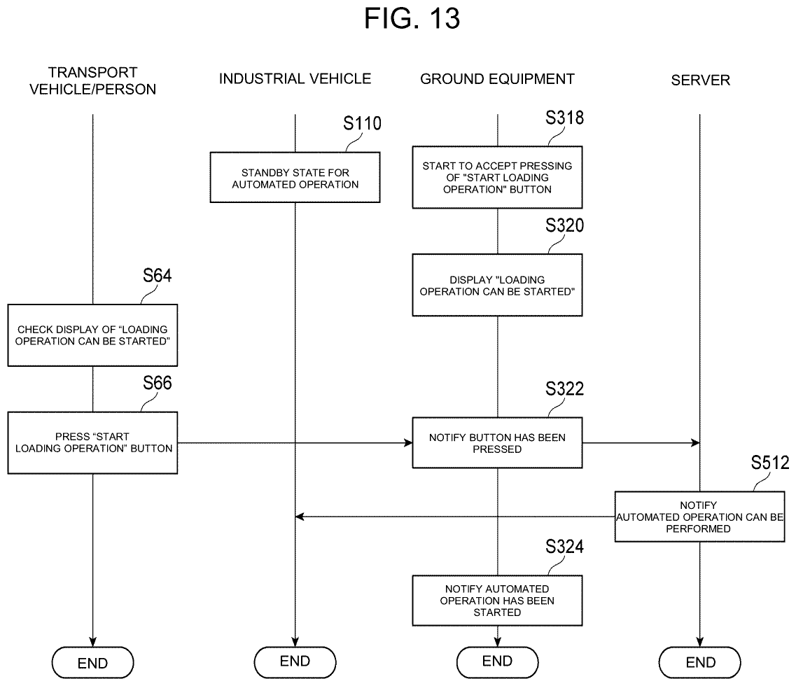

As shown in FIG. 13, when the industrial vehicle 1 receives the notification in step S316, the industrial vehicle 1 becomes in a standby state for the automated operation (step S110). The ground equipment 70 prepares for a start of the automated operation by displaying a “Start loading operation” button on the terminal 44 and starting to accept pressing of the button (step S318). In addition, the ground equipment 70 displays “Loading operation can be started” on the display unit 43 (step S320). The operator checks the display of “Loading operation can be started” at any time after this processing (step S64). The operator operates the terminal 44 and presses a “Start loading operation” button (Step S66). When the button is pressed, the ground equipment 70 notifies the server 60 that the button has been pressed (step S322). The server 60 notifies the industrial vehicle 1 that the loading operation can be performed (step S512). The ground equipment 70 notifies operators and the driver in the surrounding area by displaying information indicating that the automated operation has been started on the display unit 43 (step S324). In this way, the processing before the industrial vehicle 1 starts the automated operation is completed.

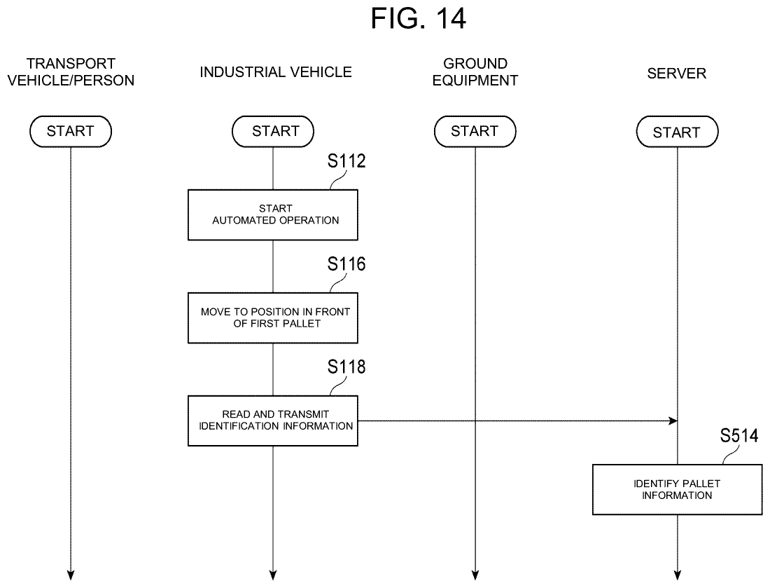

Next, contents of processing executed by the cargo handling system 100 during the cargo handling operation will be described with reference to FIGS. 14 to 20. Here, the loading operation or the unloading operation is performed as the cargo handling operation. As shown in FIG. 14, the industrial vehicle 1 automatedly starts performing the cargo handling operation (step S112). The industrial vehicle 1 moves to a position in front of a first pallet PT (step S116). In other words, the industrial vehicle 1 moves to the cargo handling position as instructed by the server 60. In a case of the unloading operation, the industrial vehicle 1 moves to the position in front of the first pallet PT on the loading platform 22 of the transport vehicle 20. In a case of the unloading operation, the industrial vehicle 1 moves to a position in front of the transition position E4. The industrial vehicle 1 reads the identification information from the identification information provider 28 of the pallet PT with the reading unit 31, and transmits the read identification information to the server 60 (step S118). The server 60 identifies the pallet information of the cargo handling target by comparing the registered data on the cloud with the received identification information (step S514). The server 60 identifies information related to the shipper of the pallet PT on which the cargo W is loaded, a type of the cargo W, the sizes of the pallet holes, and the point of origin and the destination of the pallet PT.

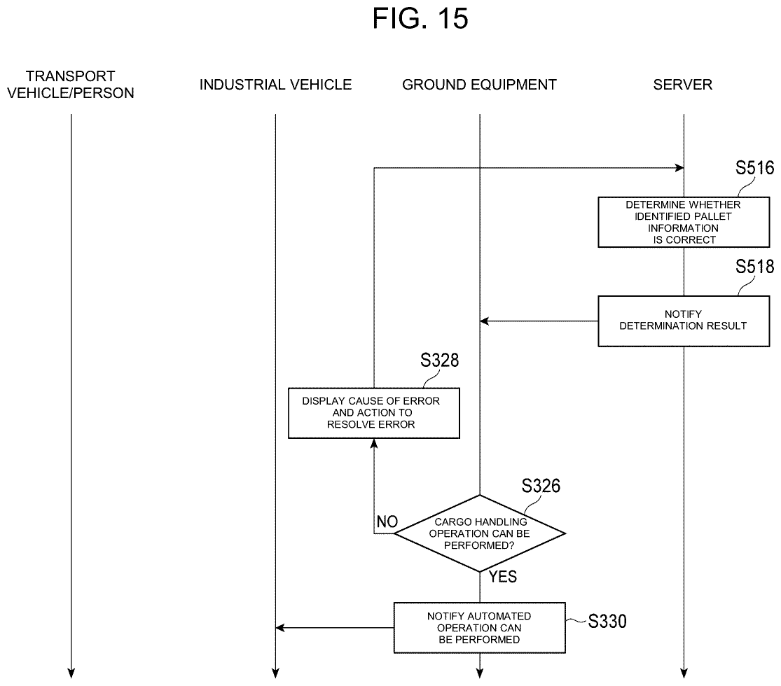

As shown in FIG. 15, the determination unit 61 of the server 60 determines whether or not the identified pallet information is correct (step S516). For example, the determination unit 61 compares the identification information of the transport vehicle 20 with the identification information of the pallet PT to determine whether the information on the point of origin of and the destination of the pallet PT are correct. The determination unit 61 notifies the ground equipment 70 of the determination result (step S518). The ground equipment 70 determines whether or not the cargo handling operation can be performed based on the determination result (step S326). In addition, when the cargo handling operation cannot be performed, the ground equipment 70 determines a cause of an error that prevents the industrial vehicle 1 to perform the cargo handling operation and an action to be taken to resolve the error. If the ground equipment 70 determines that the cargo handling operation cannot be performed, the ground equipment 70 displays a cause of an error and an action to be taken to resolve the error for the cargo handling operation on the display unit 43 (step S328). Then, the server 60 repeats processing from step S516. If the ground equipment 70 determines in step S326 that the automated operation can be performed, the ground equipment 70 notifies the industrial vehicle 1 as such (step S330). At this time, the ground equipment 70 receives fork width adjustment instruction information, and the like, from the instruction unit 62 of the server 60, and notifies the industrial vehicle 1 of the instruction information.

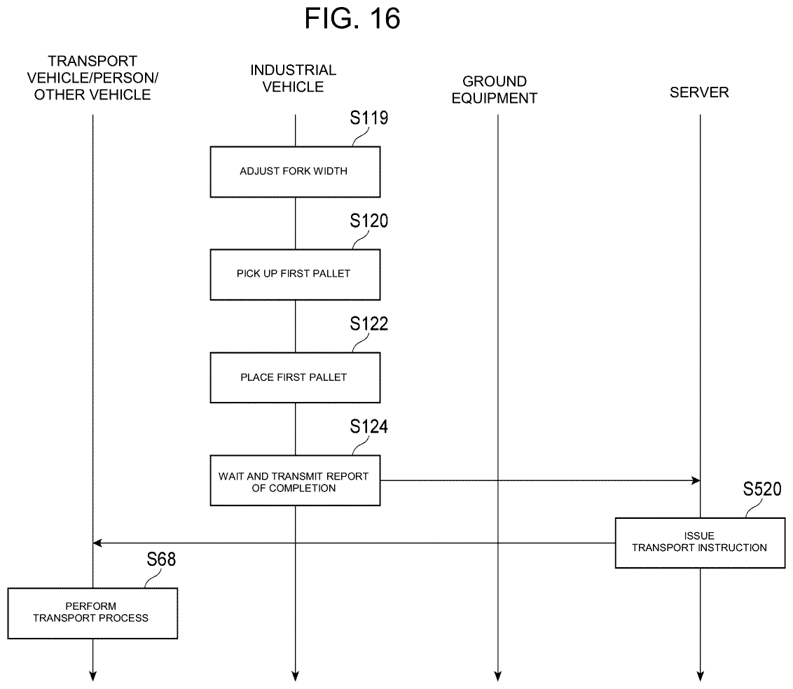

As shown in FIG. 16, the industrial vehicle 1 adjusts the fork width in accordance with the sizes of the pallet holes of the pallet PT (step S119). The industrial vehicle 1 may adjust the fork width based on the sizes of the pallet holes in the identification information of the pallet PT. Alternatively, the industrial vehicle 1 may adjust the fork width based on image analysis of the sizes of the pallet holes of the pallet PT by the monitoring unit 80. In this way, the industrial vehicle 1 may perform the cargo handling operation based on the fork width of the industrial vehicle 1 determined based on at least one of the identification information and the monitoring result by the monitoring unit 80. It is noted that the industrial vehicle 1 automatically adjust the fork width if the determined fork width is different from the current fork width. The industrial vehicle 1 picks up the first pallet PT (step S120). Then, the industrial vehicle 1 places the first pallet PT at the cargo handling position (step S122). In a case of the unloading operation, the industrial vehicle 1 places the pallet PT at the transition position E4. In a case of the loading operation, the industrial vehicle 1 places the pallet PT at the loading platform 22. When the placement of the pallet PT is completed, the industrial vehicle 1 waits with the forks removed from the pallet PT, and notifies the server 60 of the completion (step S124). The instruction unit 62 of the server 60 issues an instruction to the vehicle 1B, such as another forklift truck or an AMR, to transport the cargo (step S520). In response to that, the vehicle 1B performs a transport operation (step S68). In the case of the unloading operation, the vehicle 1B picks up the first pallet PT from the transition position E4. In the case of the loading operation, the vehicle 1B places a second pallet PT at the transition position E4.

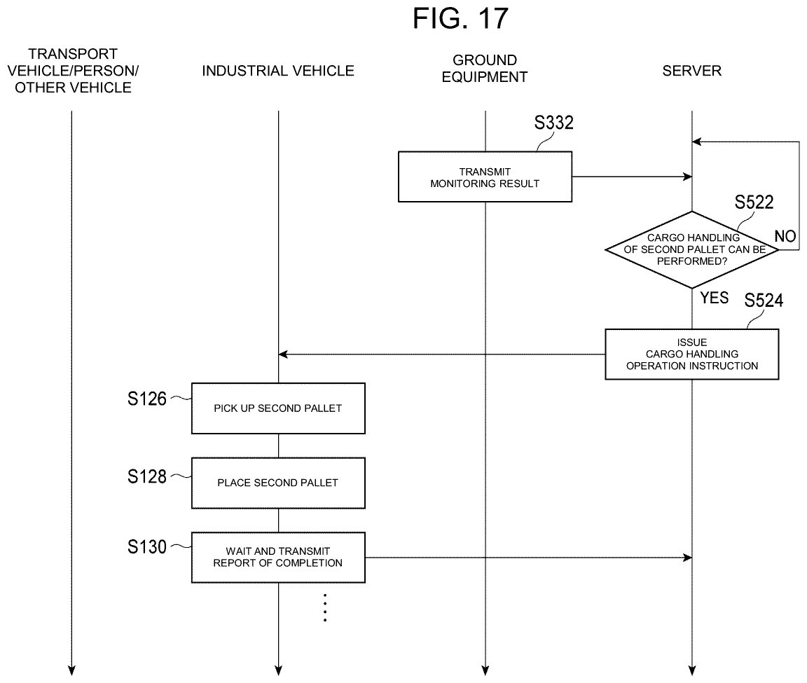

As shown in FIG. 17, the monitoring unit 40 of the ground equipment 70 transmits a monitoring result to the server 60 (step S332). The determination unit 61 of the server 60 determines whether or not the cargo handling operation of the second pallet PT can be performed (step S522). In the case of the unloading operation, the next cargo handling operation can be performed once the first pallet PT has been moved from the transition position E4. In the case of the loading operation, the next cargo handling operation can be performed once the second pallet PT has been placed at the transition position E4. When the determination unit 61 determines that the cargo handling operation cannot be performed, the determination unit 61 performs step S522 again. When the determination unit 61 determines that the cargo handling operation can be performed, the instruction unit 62 issues an instruction to the industrial vehicle 1 to perform the cargo handling operation (step S524). The industrial vehicle 1 picks up the second pallet PT (step S126). Then, the industrial vehicle 1 places the second pallet PT at the cargo handling position (step S128). When the placement of the cargo is completed, the industrial vehicle 1 waits with the forks removed from the pallet PT, and notifies the server 60 of the completion (step S130).

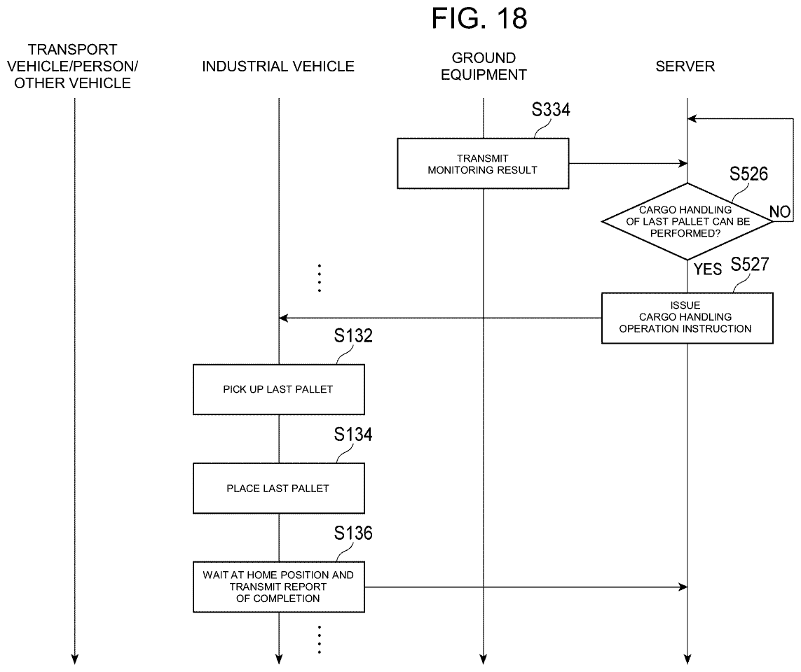

As shown in FIG. 18, the monitoring unit 40 of the ground equipment 70 transmits a monitoring result to the server 60 (step S334). The determination unit 61 of the server 60 determines whether or not the cargo handling operation of the last pallet PT can be performed (step S526). In the case of the unloading operation, the final cargo handling operation can be performed once the (the number of pallets to be transported−1)^{th} pallet PT has been moved from the transition position E4. Alternatively, the final cargo handling operation can be performed when there is no pallet PT on the loading platform 22. In the case of the loading operation, the final cargo handling operation can be performed once the last pallet PT is placed at the transition position E4. Alternatively, the final cargo handling operation can be performed when the number of pallets on the loading platform 22 becomes (the number of pallets to be transported−1). When the determination unit 61 determines that the cargo handling operation cannot be performed, the determination unit 61 performs step S526 again. When the determination unit 61 determines that the cargo handling operation can be performed, the instruction unit 62 issues an instruction to the industrial vehicle 1 to perform the cargo handling operation (step S527). The industrial vehicle 1 picks up the last pallet PT (step S132). Then, the industrial vehicle 1 places the last pallet PT at the cargo handling position (step S134). When the placement of the cargo is completed, the industrial vehicle 1 waits with the forks removed from the pallet PT at the home position, and notifies the server 60 of the completion (step S136).

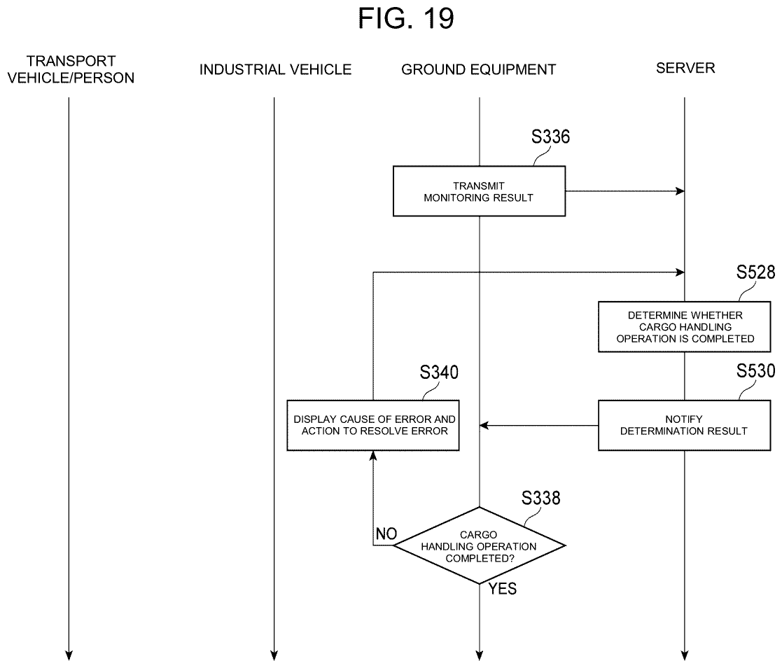

As shown in FIG. 19, the monitoring unit 40 of the ground equipment 70 transmits a monitoring result to the server 60 (step S336). The determination unit 61 of the server 60 determines whether or not the cargo handling operation is completed (step S528). The determination unit 61 of the server 60 notifies the ground equipment 70 of the determination result (step S530). The ground equipment 70 determines whether or not the cargo handling operation is completed based on the determination result (step S338). In addition, when the cargo handling operation is not completed, the ground equipment 70 determines a cause of an error that prevents the industrial vehicle 1 to complete the cargo handling operation and an action to be taken to resolve the error. If the ground equipment 70 determines in step S338 that the cargo handling operation is not completed, a cause of an error and an action an action to be taken to resolve the error are displayed on the display unit 43 (step S340). After the display of step S340, the server 60 repeats the processing from step S528.

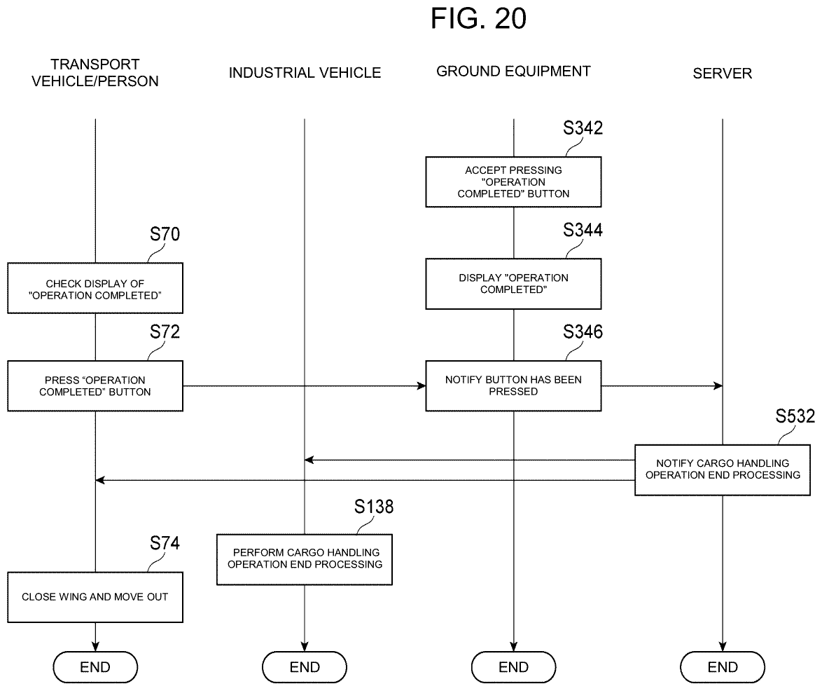

If the ground equipment 70 determines in step S338 that the cargo handling operation is completed, the ground equipment 70 accepts an “Operation completed” button as shown in FIG. 20 (step S342). The ground equipment 70 displays “Operation completed” on the display unit 43 (step S344). The operator checks the display of “Operation completed” at any time after this processing (step S70). The operator operates the terminal 44 and presses the “Operation completed” button (step S72). When the button is pressed, the ground equipment 70 notifies the server 60 that the button has been pressed (step S346). The server 60 notifies the industrial vehicle 1 and the transport vehicle 20 that cargo handling operation end processing is to be performed due to the completion of the operation (step S532). As a result, the industrial vehicle 1 performs automated operation end processing (step S138). In addition, the driver of the transport vehicle 20 closes the wings 26 and moves out of the stopping area E1 (step S74).

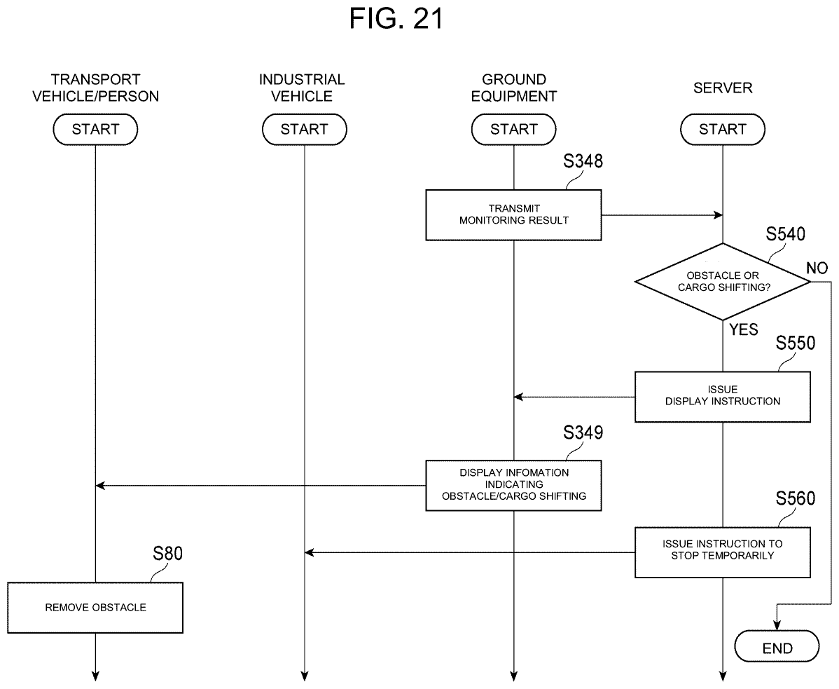

The following will describe processing to temporarily stop the automated operation of the industrial vehicle 1 during the automated operation when an obstacle enters the surrounding area of the transport vehicle 20 or when there is a possibility of cargo shifting, with reference to FIGS. 21 to 23. As shown in FIG. 21, the monitoring unit 40 transmits a monitoring result to the server 60 (step S348). The determination unit 61 determines whether or not an obstacle is present in the surrounding area of the transport vehicle 20 and whether or not there is a possibility of cargo shifting (step S540). When the determination unit 61 determines that no obstacle is present and that there is no possibility of cargo shifting, the processing shown in FIGS. 21 to 23 ends, and step S348 is performed again. If the determination unit 61 determines that an obstacle is present or there is a possibility of cargo shifting, the instruction unit 62 issues a display instruction to the display unit 43 of the ground equipment 70 (step S550). The display unit 43 displays information for an operator, indicating that an obstacle is present or there is a possibility of cargo shifting (step S349). Furthermore, the instruction unit 62 issues an instruction to the industrial vehicle 1 to stop temporarily (step S560). At any timing during this period, the operator removes the obstacle (step S80).

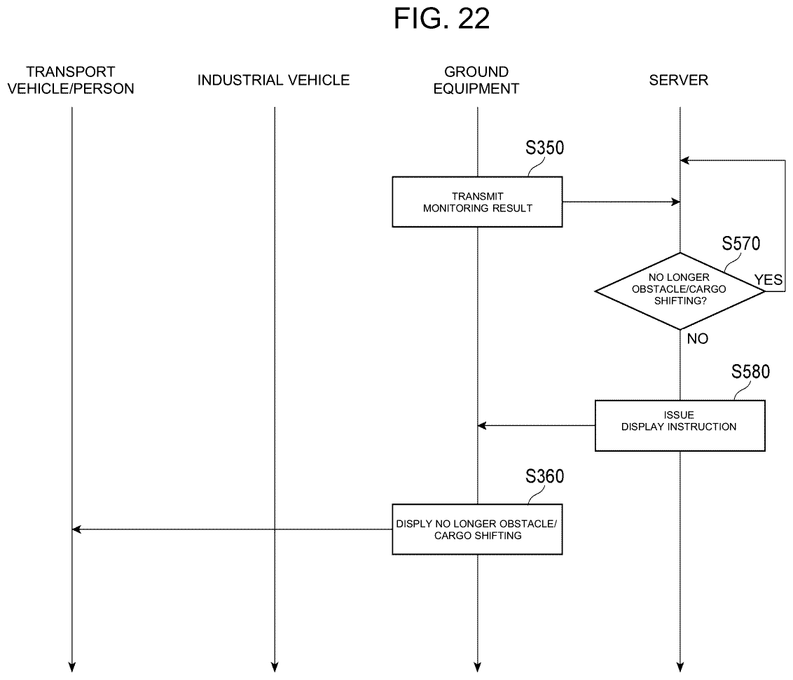

As shown in FIG. 22, the monitoring unit 40 transmits a monitoring result to the server 60 (step S350). The determination unit 61 determines whether or not an obstacle is no longer present in the surrounding area of the transport vehicle 20 and there is no longer any possibility of cargo shifting (step S570). When the determination unit 61 determines that an obstacle is present and that there is a possibility of cargo shifting, the determination unit 61 performs step S570 again. When the determination unit 61 determines that an obstacle is no longer present and there is no longer any possibility of cargo shifting, the instruction unit 62 issues a display instruction to the display unit 43 of the ground equipment 70 (step S580). The display unit 43 displays information for the operator, indicating that an obstacle is no longer present and there is no longer any possibility of cargo shifting (step S360).

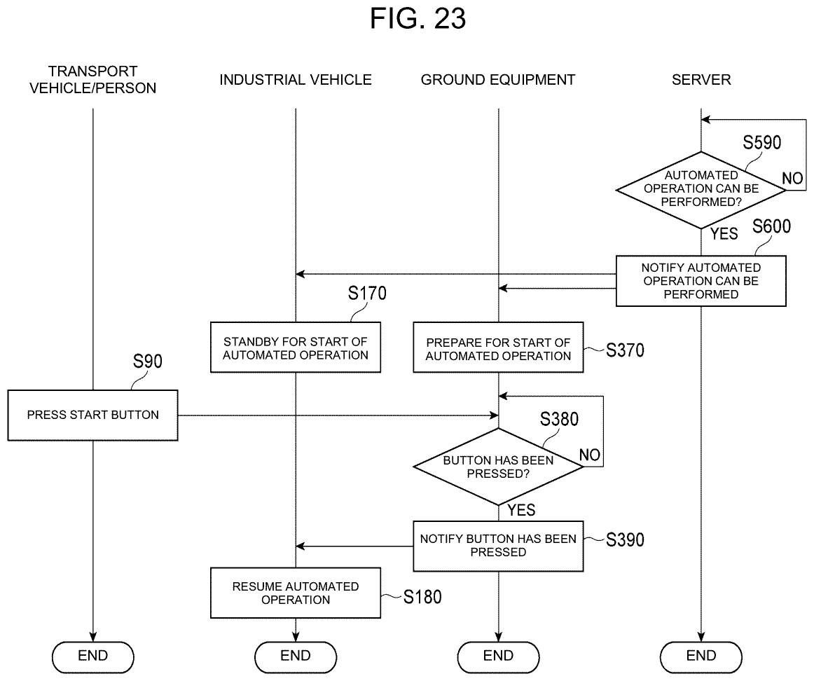

As shown in FIG. 23, the determination unit 61 determines whether or not the industrial vehicle 1 can perform the automated operation (step S590). When the determination unit 61 determines that the industrial vehicle 1 cannot perform the automated operation, the determination unit 61 performs step S590 again. When the determination unit 61 determines that the industrial vehicle 1 can perform the automated operation, the instruction unit 62 notifies the industrial vehicle 1 and the ground equipment 70 that the automated operation can be performed (step S600). In addition, the instruction unit 62 transmits instruction data necessary for the automated operation to the industrial vehicle 1 in step S600. After receiving the notification, the industrial vehicle 1 becomes in a standby state for the automated operation (step S170). The ground equipment 70 prepares for a start of the automated operation by displaying a “Start automated operation” button on the terminal 44 and starting to accept pressing of the button (step S370). The operator presses the button at any timing after this processing (step S90). The ground equipment 70 determines whether or not the button has been pressed (step S380). When the ground equipment 70 determines that the button has not been pressed, the ground equipment 70 performs step S380 again. When the ground equipment 70 determines that the button has been pressed, the ground equipment 70 notifies the industrial vehicle 1 that the button has been pressed (step S390). The industrial vehicle 1 resumes the automated operation based on the instruction data received in step S600 (step S180). Accordingly, the processing shown in FIGS. 21 to 23 ends.

Next, the operation and effects of the cargo handling system 100 according to the present embodiment will be described.

The cargo handling system 100 includes the monitoring unit 40 that is provided at a position in the work site 110 different from the industrial vehicle 1 and monitors the state of the work site 110. Therefore, the state of the work site 110 can be monitored without providing each industrial vehicle 1 with a monitoring unit with excessive performance. In the present embodiment, the industrial vehicle 1 has the monitoring unit 80. Since the cargo handling system 100 includes the monitoring unit 41, the monitoring unit 80 does not need to have high performance and be costly so as to allow the industrial vehicle 1 to perform the automated operation on its own, but may be a low cost model. Alternatively, the monitoring unit 80 may be omitted from the industrial vehicle 1. In the work site 110, a plurality of industrial vehicles 1 performs operation. If a high-performance monitoring unit is provided in each industrial vehicle 1, the same number of monitoring units as the number of industrial vehicles 1 will be required. In the present embodiment, since low-cost monitoring units 80 can be employed in the same number as the industrial vehicles 1, or the monitoring units 80 can be omitted, the cost of the cargo handling system 100 as a whole can be significantly reduced. Here, the pallet PT has the identification information provider 28 providing identification information for identifying at least one of the cargo W and the pallet PT. The cargo handling system 100 also includes the reading units 31, 45 that read the identification information provider 28. Thus, the reading units 31, 45 can read the identification information that identifies at least one of the cargo W and the pallet PT. Furthermore, the industrial vehicle 1 performs the operation based on the identification information read by the reading units 31, 45. Therefore, the industrial vehicle 1 can perform the operation without requiring the worker to identify the pallet PT. As a result, manpower-saving in the cargo handling system 100 may be achieved while the cost is reduced.

The identification information provider 28 includes the identification information for identifying the pallet PT, and the industrial vehicle 1 may perform at least one of the unloading operation and the loading operation based on the fork width of the industrial vehicle 1 and the cargo handling position, which are determined based on at least one of the identification information and the monitoring results by the monitoring units 40. In this case, the industrial vehicle 1 can adjust the fork width and move to the cargo handling position without depending on the determination by the operator.

The industrial vehicle 1 may automatically adjust the fork width when the determined fork width is different from the current fork width. In this case, the fork width of the industrial vehicle 1 can be adjusted without depending on adjustment by the operator.

The cargo handling system 100 further includes the display unit 43 that provides information in the work site 110, and the display unit 43 may provide information indicating that the unloading operation can be performed when it is determined that the cargo W is present on the loading platform 22 of the transport vehicle 20 in the work site 110. In this case, the cargo handling system 100 can easily determine which operation of the cargo handling operation is to be performed depending on the state of the loading platform 22 of the transport vehicle 20.

The cargo handling system 100 further includes the terminal 44 on which the operator can input information in the work site 110. If the loading operation instruction is input on the terminal 44 while the display unit 43 provides information indicating that the unloading operation can be performed, the instruction unit 62 may issue an instruction to at least one of the industrial vehicle 1 and another vehicle to detect a pallet PT having the identification information provider 28 providing the identification information of the loading target from the storage position. In this case, even if the cargo handling system 100 automatedly provides information indicating that the operation is unloading operation, the operation can be changed to the loading operation according to the intention of the operator at the work site 110.

The cargo handling system 100 further includes the display unit 43 that provides information in the work site 110. When it is determined that no cargo W is on the loading platform 22 of the transport vehicle 20 in the work site 110, the display unit 43 provides information indicating that the loading operation can be performed, and the instruction unit 62 may issue an instruction to at least one of the industrial vehicle 1 and another vehicle to detect a pallet PT having the identification information provider 28 providing the identification information of the loading target from the storage position.

The monitoring units 40 each may include at least one of the image acquisition unit 41 that acquires an image, and the distance measurement unit 42 that measures the distance to the target object. In this case, the monitoring units 40 can determine the state of the loading platform 22 of the transport vehicle 20 and the state of the surrounding area of the transport vehicle 20 from both of the image and the distance to the target object.

The identification information provider 28 may include at least one of a two-dimensional code and an RFID. In this case, the identification information provider 28 allows the pallet to provide the identification information easily.

The present disclosure is not limited to the above-described embodiment.

For example, the configuration of the cargo handling system including the work site illustrated in FIGS. 2 and 3 is an example, and may be changed as appropriate. The flowcharts shown in FIGS. 7 to 23 are merely an example of processing, and may be changed as appropriate.

The idea of the present disclosure is described as following [1] to [8].

[1] A cargo handling system in which an industrial vehicle performs cargo handling operation to a transport vehicle, the cargo handling system comprising:
the industrial vehicle;
a work site where the industrial vehicle perform cargo handling operation;
a monitoring unit provided at a position in the work site different from the industrial vehicle, and configured to monitor a state of the work site;
a pallet on which a cargo is placed;
an identification information provider provided in the pallet and providing identification information for identifying at least one of the cargo and the pallet; and
a reading unit configured to read the identification information provider, wherein
the industrial vehicle performs the cargo handling operation based on the identification information read by the reading unit.

[2] The cargo handling system according to [1], wherein
the identification information provider includes the identification information for identifying the pallet, wherein
the industrial vehicle performs one of unloading operation and loading operation based on a fork width of the industrial vehicle and a cargo handling position determined based on at least one of the identification information and a monitoring result by the monitoring unit.

[3] The cargo handling system according to [2], wherein
the industrial vehicle automatically adjusts the fork width when the determined fork width differs from a current fork width.

[4] The cargo handling system according to any one of [1] to [3], further comprising:
a notification unit configured to provide information in the work site; and
a determination unit configured to determine whether the cargo W is present on a loading platform of the transport vehicle in the work site, based on the identification information read by the reading unit; wherein
the notification unit provides information indicating that unloading operation is performable when the cargo is present on the loading platform of the transport vehicle in the work site.

[5] The cargo handling system according to any one of [1] to [4], further comprising:
an input unit on which an operator inputs information in the work site;
a notification unit configured to provide information in the work site; and
an instruction unit configured to transmit an instruction to the industrial vehicle, wherein
when a loading instruction is input to the input unit while the notification unit provides the information indicating that unloading can be performed, the instruction unit issues an instruction to at least one of the industrial vehicle and another vehicle to detect the pallet having the identification information provider providing the identification information of a loading target from a storage position.

[6] The cargo handling system according to any one of [1] to [5], wherein
a notification unit configured to provide information in the work site;
a determination unit configured to determine whether the cargo W is present on a loading platform of the transport vehicle in the work site, based on the identification information read by the reading unit; and
an instruction unit configured to transmit an instruction to the industrial vehicle, wherein
the notification unit provides information indicating that loading is performable when the cargo is not present on the loading platform of the transport vehicle in the work site,
the instruction unit issues an instruction to at least one of the industrial vehicle and another vehicle to detect the pallet having the identification information provider providing the identification information of a loading target from a storage position.

[7] The cargo handling system according to any one of [1] to [6], wherein
the monitoring unit include at least one of an image acquisition unit that acquires an image, and a distance measurement unit that measures a distance to a target object.

[8] The cargo handling system according to any one of [1] to [7], wherein
the identification information provider include at least one of a two-dimensional code and an RFID.

What is claimed is:

1. A cargo handling system in which an industrial vehicle performs a cargo handling operation for a transport vehicle, the cargo handling system comprising:
the industrial vehicle;
a work site where the industrial vehicle performs the cargo handling operation;
a monitoring unit provided at a position in the work site different from the industrial vehicle, and configured to monitor a state of the work site;
a pallet on which a cargo is placed;
an identification information provider provided in the pallet and providing identification information for identifying at least one of the cargo and the pallet; and
a reading unit configured to read the identification information provider, wherein
the industrial vehicle performs the cargo handling operation based on the identification information read by the reading unit.

2. The cargo handling system according to claim 1, wherein
the identification information provider provides the identification information for identifying the pallet, and
the industrial vehicle performs one of an unloading operation and a loading operation based on a fork width of the industrial vehicle and a cargo handling position determined based on at least one of the identification information and a monitoring result by the monitoring unit.

3. The cargo handling system according to claim 2, wherein
the industrial vehicle automatically adjusts the fork width when the determined fork width differs from a current fork width.

4. The cargo handling system according to claim 1, further comprising
a notification unit configured to provide information in the work site, and
a determination unit configured to determine whether the cargo is present on a loading platform of the transport vehicle in the work site, based on the identification information read by the reading unit, wherein
the notification unit provides information indicating that an unloading operation is performable when the cargo is present on the loading platform of the transport vehicle in the work site.

5. The cargo handling system according to claim 1, further comprising:
an input unit on which an operator inputs information in the work site;
a notification unit configured to provide information in the work site; and
an instruction unit configured to transmit an instruction to the industrial vehicle, wherein
when a loading operation instruction is input on the input unit while the notification unit provides the information indicating that an unloading operation is performable, the instruction unit issues an instruction to at least one of the industrial vehicle and another vehicle to detect the pallet having the identification information provider providing the identification information of a loading target from a storage position.

6. The cargo handling system according to claim 1, further comprising:
a notification unit configured to provide information in the work site;
a determination unit configured to determine whether the cargo is present on a loading platform of the transport vehicle in the work site, based on the identification information read by the reading unit; and
an instruction unit configured to transmit an instruction to the industrial vehicle, wherein
the notification unit provides information indicating that a loading operation is performable when the cargo is not present on the loading platform of the transport vehicle in the work site,
the instruction unit issues an instruction to at least one of the industrial vehicle and another vehicle to detect the pallet having the identification information provider providing the identification information of a loading target from a storage position.

7. The cargo handling system according to claim 1, wherein
the monitoring unit includes at least one of an image acquisition unit that acquires an image, and a distance measurement unit that measures a distance to a target object.

8. The cargo handling system according to claim 1, wherein
the identification information provider includes at least one of a two-dimensional code and an RFID.
